(19) United States
(12) Patent Application Publication
(10) Pub. No.: US 2009/0222281 A1
(43) Pub. Date: Sep. 3, 2009

(54) FORMULATION FOR MULTI-STEP ACNE TREATMENT

(76) Inventor: Vibhuti Uppal, (US)

Correspondence Address: Cigno (B.V.I.) Ltd., Gotthardstrasse 52, Thalwil, 88000, CH

(21) Appl. No.: 12/041,162

(22) Filed: Mar. 3, 2008

(51) Int. Cl. G06Q 50/00

(52) U.S. Cl. 705/2

(57) ABSTRACT

Methods and systems (150) for hosting multi-step acne treatment program are disclosed. Profile of individuals is maintained through Customer Relationship module (140). Individual customers, skincare clinics and online skincare retailers use treatment Customizer (120) to build a multi-step acne treatment. Processing of customer orders and payment processing will be supported by Order Management (160) and Billing (110)

### BACKGROUND

1. Field

The present embodiments relate generally to methods for providing individuals affordable and over the counter (OTC) choice for personalized treatment for acne based on different skin types.

2. Background

Acne is a skin condition caused by blockage and/or inflammation of sebaceous glands. It is the single most common skin condition affecting 85% of all adolescents. Between 41 and 48 million Americans are affected with acne. By age 18, as many as 25% of adolescents will have scarring attributed to acne. Acne can last from 6-14 years and may persist into the third to fifth decade of life, particularly in women. Traditional treatments include over-the-counter topical medications and prescription topical or oral antibiotics. Many other OTC treatments are not effective and prescription antibiotics must be taken for a long time with the associated risks of resistance. Even the Photodynamic Therapy (PDT) has not worked effectively for most individuals with acne condition. This group of therapies account for more than $2.1 billion in total acne market sales in U.S. alone.
There have been no new, innovative products to treat acne in several years, yet there remains an unmet medical need. Though rarely severe from a medical standpoint, acne is a widespread and embarrassing condition.

Present methods do not provide any form of personalized acne treatment based on skin type, type of breakouts and frequency of breakouts.

### SUMMARY

Embodiments disclosed herein address the above stated needs by considering the opportunity for individuals requiring OTC acne treatment which is fragrance free, allergen free and paraban free. Accordingly, embodiments of the invention include methods and systems for selecting and treating acne. The service based on methods and systems described below will guide individuals to select personalized acne treatment based on their skin type, type of breakouts and frequency of breakouts.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 illustrates a system for implementing various embodiments of the invention;

FIG. 2 illustrates logic elements and formulations in accordance with at least one embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Embodiments of the invention allow customers, skincare clinics and online skincare retailers to order multi-step acne treatment based on the selection of skin type and breakout frequency as shown in Table 1 below.

TABLE 1

| | | Step 1 - Face wash | | | | Step 2 - | | | | Step 3 - Spot |
|---|---|---|---|---|---|---|---|---|---|---|
| | | (with microbeads for exfoliation) | | | | Treatment gel | | | | Treatment |
| | | Formulation No. | | | | | | | | |
| | | 1 | 2 | 3 | 4 | 5 | 6 | 7 | 8 | 9 |
| Breakout | Sensitive | ✓ | ✓ | | | ✓ | ✓ | | | |
| Skin | Non-sensitive | | | ✓ | ✓ | | | ✓ | ✓ | ✓ |
| | Few | ✓ | | ✓ | | ✓ | | ✓ | | |
| | Frequent | | ✓ | | ✓ | | ✓ | | ✓ | |

| | |
|---|---|
| Formulations | 1. Glycolic acid 5% + botanical complex 1 |
| | 2. Glycolic acid 10% + salicylic acid 2% + botanical complex 2 |
| | 3. Benzoyl peroxide 5% + sulfur + botanical complex 1 |
| | 4. Benzoyl peroxide 10% + sulfur + botanical complex 2 |
| | 5. Salicylic acid gel 2% + botanical complex 1 |
| | 6. Salicylic acid gel 2% + glycolic 10% gel + botanical complex 2 |
| | 7. Salicylic acid gel 2% + glycolic 10% gel + alcohol + botanical complex 1 |
| | 8. Benzoyl peroxide 5% gel + sulfur + botanical complex 2 |
| | 9. Benzoyl peroxide 10% + sulfur |

Other ingredients (inactive): include the following
Botanical complex 1: Witch hazel, rose water, chamomile oil, green tea, jojoba oil, lactic acid
Botanical complex 2: Llactic acid, lemon juice concentrate, menthol, witch hazel, tea tree oil,
eucalyptus oil, rose water, chamomile oil, green tea, neem oil

Based on the skin type and breakout frequency combination shown in Table 1, the logic in module 120 Treatment Customizer will then select appropriate combination of formulations for the multi-step acne treatment corresponding to the steps in Table 1.

First time customers will be required to register with Cleardermdystem using the logic for the customer relationship management (CRM) module 140.

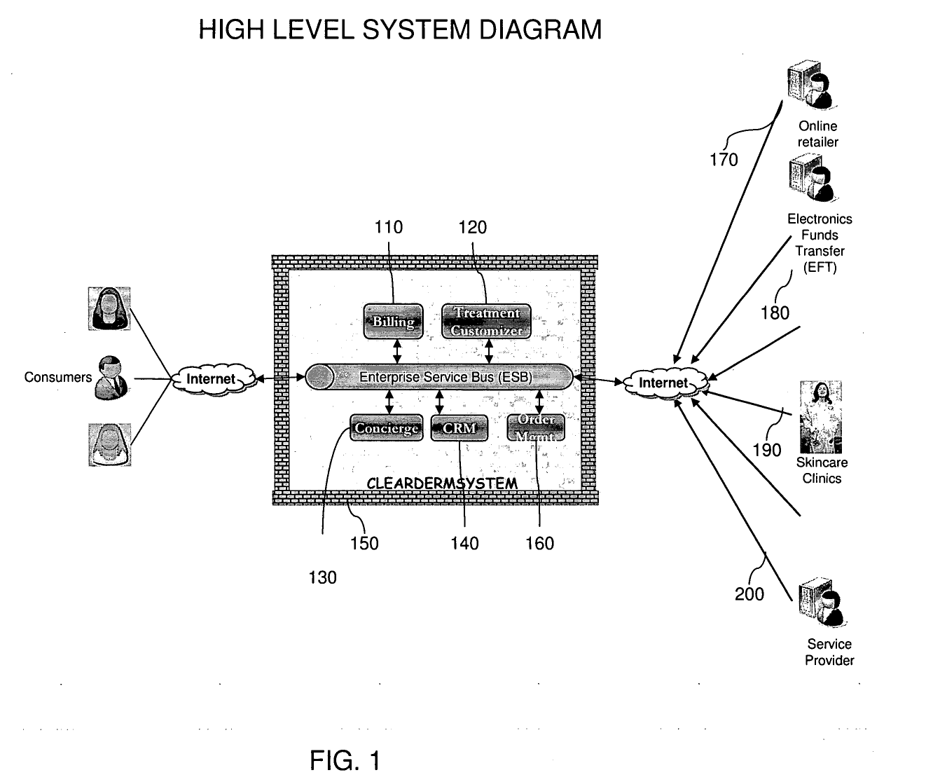

Referring to FIG. 1, a system level diagram is illustrated showing an exemplary architecture according to at least one embodiment of the invention. For example, individuals, skincare clinics and online skincare retailers will be guided to a suitable formation for the multi-step acne treatment by the treatment customizer.

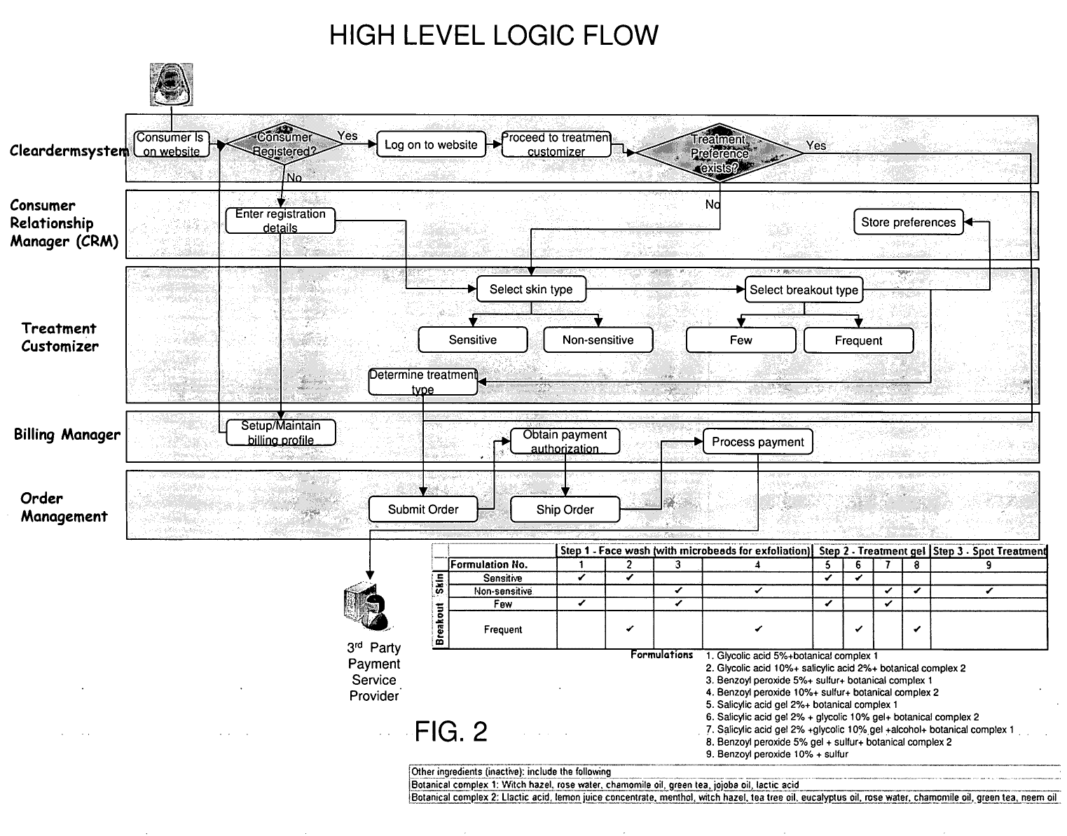

Referring to FIG. 2, a system for ordering personalized multi-step acne treatment is illustrated. The system can include logic 120 to identify suitable formulation for each of the multi-step acne treatment. The Billing module 110 has the logic to process payments of customers, online skincare retailers and skincare clinics placing online orders.

Logic in module 130 Concierge allows partners to buy and sell skincare products or services from each other including third-party service and content providers, buy gift vouchers which can be redeemed by other customers.

Those of ordinary skill in the art understand that data, information and signals may be represented in a number of different ways, using various technologies and techniques. The logical blocks in the flow charts, circuits, and components described in connection with the various embodiments may be implemented as hardware, software, firmware, or some combination thereof. Those of ordinary skill in the art would know to implement the described embodiments using various design options, depending upon the particular constraints and considerations of the situation. Such design choices are not a departure from the scope of the present invention.

The various logical blocks depicted in the flow charts, circuits, and components may be implemented using a personal computer, a microprocessor, a controller, a digital signal processor (DSP), an application specific integrated circuit (ASIC), using discrete or integrated circuitry, or a combination of these. A general purpose processor may be a microprocessor, but in the alternative, the processor may be any conventional processor, microcontroller, or state machine.

The method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a DVD/CD, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The various steps and activities in the embodiments described herein may be performed in the exemplary order illustrated in the figures, or another order, depending upon the particularities of the implementation. Various other activities and steps may be performed in a sequence other than that illustrated in the figures.

The disclosure of the various embodiments is provided so as to enable those of ordinary skill in the art to make and use the present invention. Design choices and modifications to the various embodiments will occur to practitioners of ordinary skill in the art without departing from the spirit or scope of the invention. The present invention is not intended to be limited only to those specific versions which are discussed herein for the sake of illustration, but is to be accorded the widest scope for the features and aspects of the invention enabled herein and recited in the appended claims.

What is claimed is:

1. A method for allowing an individual, skincare clinic or online skincare retailer to select over the counter multi-step acne treatment based on the skin type and breakout frequency.

2. A system comprising logic for providing multi-step acne treatment, comprising:
logic configured to determine which type of acne treatment is most suitable for an individual;
logic configured to determine which formulation is most suitable for each of the multi-steps of the acne treatment.

3. A computer readable media embodying a method of hosting multi-step acne treatment, the method comprising:
setting up and storing individual preferences based on skin type and break out frequency; and
selecting correct formulation for each of the multi-step acne treatment.
